(19) United States
(12) Patent Application Publication
(10) Pub. No.: US 2008/0128409 A1
(43) Pub. Date: Jun. 5, 2008

(54) COMBINATION OVEN ASSEMBLY AND METHOD

(76) Inventor: Steve B. Froelicher, Shepherdsville, KY (US)

Correspondence Address: GENERAL ELECTRIC CO.;GLOBAL PATENT OPERATION, 187 Danbury Road, Suite 204, Wilton, CT, 06897-4122, US

(21) Appl. No.: 11/566,293

(22) Filed: Dec. 4, 2006

(51) Int. Cl. H05B 6/64

(52) U.S. Cl. 219/680

(57) ABSTRACT

A combination oven assembly includes a housing defining an interior cavity. A microwave cooking subassembly is configured to direct microwave energy into the interior cavity. A turntable is disposed in the interior cavity. A radiant heating element is disposed outside of the interior cavity.

### BACKGROUND OF THE INVENTION

The described technology relates to a combination oven assembly and corresponding method.

It is known to provide a microwave cooking subassembly, radiant cooking subassembly and natural or forced convection cooking subassembly in a conventional combination oven. By this arrangement, a variety of foods can be cooked in various cooking modes. Specifically, food can be cooked by any one of the microwave, radiant or convection cooking subassemblies, or can be cooked by any combination of the microwave, radiant and convection cooking subassemblies.

Conventional combination ovens suffer, however, from a number of disadvantages. For example, because of the arrangement of components in the conventional combination oven, some foods are not uniformly cooked, particularly when cooking only with the microwave subassembly. Further, the interior of the combination oven is not quickly and uniformly pre-heated or heated, particularly prior to and during baking and roasting with the radiant or convection cooking subassemblies.

### BRIEF DESCRIPTION OF THE INVENTION

As described herein, embodiments of the invention overcome one or more of the above or other disadvantages known in the art.

In an embodiment, a combination oven assembly includes a housing defining an interior cavity. A microwave cooking subassembly is configured to direct microwave energy into the interior cavity. A turntable is disposed in the interior cavity. A radiant heating element is disposed outside of the interior cavity.

In another embodiment, a method for operating a combination oven includes selectively directing microwave energy into an interior cavity of the oven, selectively directing energy into the interior cavity with a heating element disposed outside of the interior cavity, and selectively operating a turntable disposed in the interior cavity.

### BRIEF DESCRIPTION OF THE DRAWINGS

The following figures illustrate examples of embodiments of the invention. The figures are described in detail below.

FIG. 1 is a side cross sectional view of an embodiment of a combination oven assembly.

FIG. 2 is a partial cross sectional view of a cooking subassembly of the combination oven assembly of FIG. 1, taken along line II-II in FIG. 1.

FIG. 3 is an isometric view of components of the cooking subassembly of FIG. 2.

### DETAILED DESCRIPTION OF EMBODIMENTS OF THE INVENTION

Embodiments of the invention are described below, with reference to the figures. Throughout the figures, like reference numbers indicate the same or similar components.

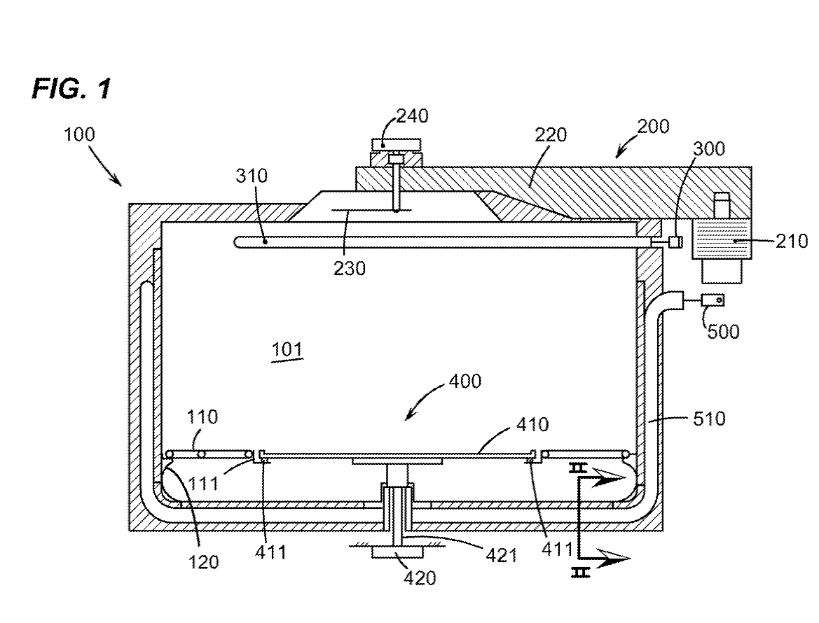

FIG. 1 is a side cross sectional view of an embodiment of a combination oven assembly. The combination oven assembly 100 can include a plurality of cooking subassemblies. Although the drawings show embodiments of the combination oven assembly 100 as including particular cooking subassemblies 200, 300, 400 and 500, which are described in detail below, it is understood that the combination oven assembly 100 does not require all of the cooking subassemblies 200, 300, 400 and 500. Rather, the combination oven assembly 100 can include one, two, three or all four of these cooking subassemblies, and/or other cooking subassemblies. It is also to be understood that the terms “cook,” “cooks,” “cooking” and variations thereof include cooking, broiling, grilling, defrosting, preheating, reheating, combination cooking and other heating operations performed on foods, while the terms “heat,” “heats,” “heating” and variations thereof include heat transfer and energy transfer.

It is contemplated that the combination oven assembly 100 will have exterior and interior dimensions similar to those of conventional over the range ovens, and that the combination oven assembly 100 is suited for use as a second oven, installed over a range and/or another oven. It is understood, however, that the combination oven assembly 100 is not limited to this use or disposition, and that the combination oven assembly 100 can be installed in other locations, with or without a range or another oven.

In the embodiments shown in the drawings, the cooking subassembly 200 is a microwave cooking subassembly. The microwave cooking subassembly 200 is configured to cook foods with microwave energy, by directing microwave energy into an interior cavity 101 of an oven housing of the combination oven assembly 100. Thus, although the drawings show specific components of the microwave cooking subassembly 200, it is understood that the microwave cooking subassembly 200 does not require these particular components, and can include additional or different components, as long as the microwave cooking subassembly 200 is configured to cook foods with microwave energy.

As shown in the drawings, the microwave cooking subassembly 200 includes a radio frequency generator 210 (such as a magnetron assembly), a radio frequency waveguide 220, an antenna 230 and an antenna rotation assembly 240. These components of the microwave cooking subassembly 200 operate in a known manner, such that foods disposed within the interior cavity 101 can be cooked by microwave energy. Further explanation of the microwave cooking subassembly 200 is therefore not necessary. In the embodiments shown in the drawings, the microwave cooking subassembly 200 is disposed adjacent and through an opening in a top surface of the interior cavity 101, with the radio frequency generator 210 disposed outside of the interior cavity 101 and adjacent a back surface of the interior cavity 101 which is opposite both a front surface and a door that permits and prohibits access to the interior cavity 101. It is understood, however, that the microwave cooking subassembly 200 is not limited to this disposition.

In the embodiments shown in the drawings, the cooking subassembly 300 is a broil cooking subassembly. The broil cooking subassembly 300 is configured to cook foods with radiant energy, by directing radiant energy into the interior cavity 101. Thus, although the drawings show the broil cooking subassembly as including a single broil coil assembly 310, it is understood that the broil cooking subassembly 300 does not require the single broil coil assembly 310, and can include additional or different components, as long as the broil cooking subassembly 300 is configured to cook foods with radiant energy. The broil cooking subassembly 300 can be configured to cook foods through the application of relatively high heat, directly or in close proximity to the foods, in a known manner. Further explanation of the broil cooking subassembly 300 is therefore not necessary. In the embodiments shown in the drawings, the broil cooking subassembly 300 is disposed adjacent the top surface of the interior cavity 101, and through an opening in the back surface of the interior cavity 101. It is understood, however, that the broil cooking subassembly 300 is not limited to this disposition.

The cooking subassembly 400 is configured to rotate foods disposed in the interior cavity 101 of the combination oven assembly 100. This rotation can occur one or more of before, during and after cooking with none of, or one or more of, the cooking subassemblies 200, 300 and 500 and/or with other cooking subassemblies. Further, the rotation can occur in one or more of a clockwise and counterclockwise direction, constantly or intermittently, through arcs between 0 and 360 degrees, one or more times, such that the cooking subassembly 400 rotates foods either partially or completely around an axis.

Thus, the cooking subassembly 400 is a rotational subassembly. Although the drawings show specific components of the rotational subassembly 400, it is understood that the rotational subassembly 400 does not require these particular components, and can include additional or different components, as long as the rotational subassembly 400 is configured to rotate foods as discussed above.

In the drawings, the rotational subassembly 400 includes a turntable rack 410, which is configured to receive thereon foods disposed in the interior cavity 101 of the combination oven assembly 100. The turntable rack 410 can be of various configurations. For example, the turntable rack 410 can be a grating, a grill, a solid surface, or combinations thereof. The turntable rack 410 can be manufactured from a variety of materials having various properties. For example, the turntable rack 410 can be manufactured from glass, ceramic, metal, or plastic, chosen to have desired heat conductive or insulative properties, and/or to be resistant to heating with any or all of the cooking subassemblies 200, 300 and 500.

In the embodiments shown in the drawings, the turntable rack 410 includes at least one wheel 411 on a bottom surface thereof. The interior cavity 101 of the combination oven 100 includes a bottom rack 110 defining a turntable void. The turntable rack 410 is disposed in the turntable void of the bottom rack 110. The bottom rack 110 includes a wheel track 111 configured to permit rotation of the wheel 411 of the turntable rack 410 thereon. By this arrangement, rotation of the turntable rack 410 within the interior cavity 101 of the combination oven assembly 100 is facilitated by rotation of the wheel 411 on the wheel track 111. As illustrated, the turntable rack includes a plurality of wheels 411, each of which contacts the wheel track 111. The bottom rack 110 can be of various configurations. For example, the bottom rack 110 can be a grating, a grill, a solid surface, or combinations thereof. The bottom rack 110 can be manufactured from a variety of materials having various properties. For example, the bottom rack 110 can be manufactured from glass, ceramic, metal, or plastic, chosen to have desired heat conductive or insulative properties, and/or to be resistant to heating with any or all of the cooking subassemblies 200, 300 and 500. Although the drawings show the wheel track 111 having an about L-shaped cross section, the wheel track 111 can have different shapes, as long as the wheel or slide track 111 can aid in the guidance of the wheel 411 and/or facilitate rotation of the turntable rack 410. It is understood that the wheel 411 and/or the wheel track 111 can be omitted from the rotational subassembly 400. In alternate embodiments of the invention, one or more slides (e.g., protrusions configured to permit and/or facilitate sliding of the turntable rack 410, such as on a slide track disposed in place of the wheel track 111 on the bottom rack 110) can be used in place of the one or more wheels.

The turntable rack 410 shown in the drawings has an at least about circular shape, and is configured to rotate within a corresponding circular turntable void in the bottom rack 110, such that the turntable rack 410 is embedded in the bottom rack 110. It is understood, however, that the turntable rack 410 is not limited to an at least about circular shape, but rather can be any shape, as long as foods placed thereon are rotated, in the above-discussed manner, by the rotational subassembly 400. An upper surface of the turntable rack 410 can be above, even or below an upper surface of the bottom rack 110 (i.e., a surface of the turntable rack 410 on which foods are placed can be disposed in a plane at a higher elevation, at an about the same elevation, or at a lower elevation than a plane in which is disposed a surface of the bottom rack 110 on which foods are placed).

As shown in the drawings, the rotational subassembly 400 includes a motor 420 with a motor shaft 421. The motor shaft 421 extends through the bottom surface of the interior cavity 101 of the combination oven assembly 100, and connects the motor 420 to the turntable rack 410. By this arrangement, operation of the motor 420 results in rotation of the motor shaft 421, which in turn results in rotation of the turntable rack 410. It is understood that such a direct connection between the motor 420 and the turntable rack 410 is not required, and that when present the motor shaft 421 is not required to extend through the bottom surface of the interior cavity 101.

It is also to be understood that the rotational subassembly 400 can be used, but is not required to be used, during cooking with one or more of the cooking subassemblies 200, 300 and 500, and/or other cooking subassemblies, to provide more even cooking during any or all cooking modes. Thus, removal of the turntable rack 410 is not required during any or all cooking operations with the combination oven assembly 100, even when the rotational subassembly 400 is not being used. In a specific embodiment, the rotational subassembly 400 may be particularly useful during cooking with the microwave cooking subassembly 200. As discussed above, it is contemplated that the combination oven assembly 100 may have the relatively large size and be placed in the location of a conventional over the range oven. As such, use of the rotational subassembly 400 during cooking with the microwave cooking subassembly 200 may provide much more thorough and uniform cooking, as it is contemplated that there may be a relatively large distance between the microwave cooking subassembly 200 and the foods being cooked, and/or the volume of the foods being cooked may be relatively much less than the volume of the interior cavity 101.

In the illustrated embodiments, the front and back surfaces of the interior cavity 101 include protrusions 120, which support the bottom rack 110. As discussed above, the wheel track 111 of the bottom rack 110 supports the turntable rack 410. Thus, the bottom rack 110 can be placed in the interior cavity 101, and the turntable rack 410 can then be placed on the bottom rack 110. Further, the turntable 410 can be removed from the interior cavity 101 before the bottom rack 110 can be removed, such as for cleaning of the turntable 410, the bottom rack 110, and/or the interior cavity 101. It is understood, however, that components of the combination oven assembly 100 can be sized, shaped and disposed such that other assembly and disassembly orders are permitted.

The cooking subassembly 500 is configured to cook foods by radiant energy and natural or forced convection energy, by heating surfaces of the interior cavity 101 from an exterior or outside of the interior cavity 101. Specifically, heat from the cooking subassembly 500 is radiated to the foods in the interior cavity 101 of the combination oven assembly 100. Natural air currents develop on surfaces of the interior cavity 101 as the air is heated. Although not shown in the drawings, a fan can be provided in the cooking subassembly 500 to accomplish more even heating of the air in the interior cavity 101. Thus, the cooking subassembly 500 is a radiant and natural or forced convection cooking subassembly (referred to as a radiant cooking subassembly 500 hereafter for convenience).

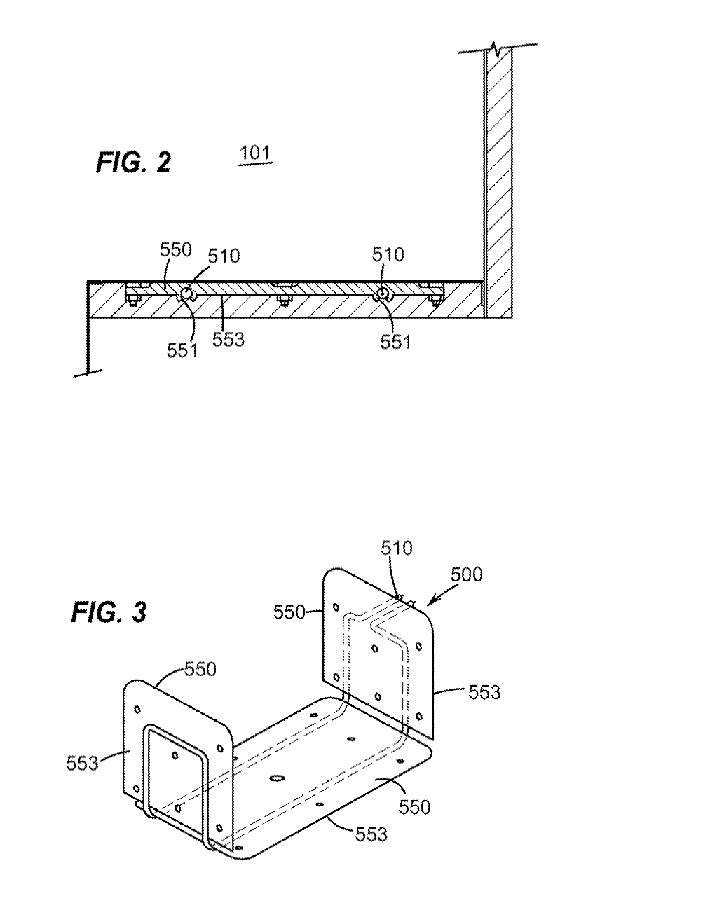

FIG. 2 is a partial cross sectional view of the combination oven assembly 100, showing the radiant cooking subassembly 500, and FIG. 3 is an isometric view of components of the radiant cooking subassembly 500. Although the drawings show specific components of the radiant cooking subassembly 500, it is understood that the radiant cooking subassembly 500 does not require these particular components, and can include additional or different components, as long as the radiant cooking subassembly 500 is configured to cook foods by radiant energy and/or natural or forced convection energy.

In the embodiments shown in the drawings, the radiant cooking subassembly 500 includes at least one radiant heating element 510 and at least one heat distribution plate 550 at least adjacent thereto. By this arrangement, the heat distribution plate 550 is heated by the heating element 510. Because the heat distribution plate 550 acts as a heat sink, and has a relatively greater surface area than that of the heating element 510, it is understood than the interior cavity 101 of the combination oven assembly 100 is more quickly and/or more uniformly heated as compared to cooking subassemblies that do not include a heat distribution plate heated by a heating element.

As shown in the drawings, the heating element 510 contacts the heat distribution plate 550, and more specifically is disposed in at least one channel 551 on a bottom surface 553 (e.g., a surface disposed away from the interior cavity 101) of the heat distribution plate 550. The channel 551 can be crimped, so that the heating element 510 is retained in the heat distribution plate 550. In the illustrated embodiments, three (3) of the heat distribution plates 550 are placed on left and right surfaces (i.e., surfaces between the front and back surfaces), as well as on the bottom surface, of the interior cavity 101 of the combination oven assembly 100. However, it is understood that the heat distribution plates 550 are not required on any or all of these surfaces of the interior cavity 101, and can be disposed on none of, or one or more of, these surfaces, and/or other surfaces of the interior cavity 101. Further, the heating element 510 need not be in either full or partial contact with the heat distribution plate 550, but rather can be spaced apart from the heat distribution plate 550. In the illustrated embodiments, each of the heat distribution plates 550 includes at least one channel 551 in which the single, radiant heating element 510 is disposed and crimped so as to be retained in the radiant cooking subassembly 500.

In the embodiments shown in the drawings, the radiant cooking subassembly 500 is disposed such that the heat distribution plates 550 are integrated into (form at least a portion of) the left, right and bottom surfaces of the interior cavity 101. As a result, the volume of the interior cavity 101 is not diminished by the protrusion of the heat distribution plates 550 therein. Further, a large volume on an outside of the combination oven assembly 100 is not required for structure associated with the radiant cooking subassembly 500. Still further, cleaning of the interior cavity 101 is greatly facilitated, as the radiant cooking subassembly 500 does not protrude into the volume of the interior cavity 101.

The size, shape, and extent to which one or more components of the radiant cooking subassembly 500 extend within the interior cavity 101 (e.g., the distance that the heating element 510 and/or the heat distribution plates 550 extend along the left, right, and bottom surfaces of the interior cavity 101) are determined based on desired operating characteristics of the radiant cooking subassembly 500 and/or the combination oven assembly 100. Similarly, components of the radiant cooking subassembly 500 can be manufactured from a variety of materials having various properties. For example, the heat distribution plates 550 can be manufactured from metal, such as aluminum, chosen because of its desired heat conductive properties.

It is understood that the radiant cooking subassembly 500 can be used during cooking with none of, or one or more of, the cooking subassemblies 200, 300 and 400, and/or other cooking subassemblies. It is contemplated that the radiant cooking subassembly 500 may be particularly useful during preheating or heating, while baking or roasting. As discussed above, it is contemplated that the combination oven assembly 100 may have the relatively large size and be placed in the location of a conventional over the range oven. As such, use of the radiant cooking subassembly 500 may provide much more thorough and uniform cooking, as it is contemplated that the volume of the foods being cooked may be relatively much less than the volume of the interior cavity 101.

It is understood that other features and components of the combination oven assembly 100 can be the same as or similar to those of conventional ovens, including conventional combination ovens. For example, the surfaces of the interior cavity 101 of the combination oven assembly 100 can be covered with enamel, in a known manner. Further, the surfaces of the interior cavity 101 can be appropriately insulated, such as with insulation of approximately 0.5 inch (1.27 cm) in thickness, with a heavy foil back layer on an outside face, as also known.

Use of the radiant cooking subassembly 500 avoids disadvantages of conventional combination ovens. By way of non-limiting examples, by using the heat distribution plates 550, localized heating of portions of the radiant cooking subassembly 500 (such as portions adjacent the heating element 510) to a temperature exceeding approximately 940 degrees Fahrenheit (34.4 degrees Celsius) is avoided. Thus, crazing or cracking of the enamel covering, which occurs in conventional combination ovens under these conditions, is also avoided.

In embodiments of the invention, one or more well studs in the form of a threaded fastener can be welded to an exterior wall of one or more of the heat distribution plates 550. The threaded fasters can cooperate with corresponding nuts, to securely fasten the radiant cooking subassembly 500 within the interior cavity 101 of the combination oven assembly 100. By this arrangement, effective and efficient heat transfer can occur between the surfaces of the interior cavity 101 and the heat distribution plates 550 of the radiant cooking subassembly 500.

This written description uses examples to disclose embodiments of the invention, including the best mode, and also to enable a person of ordinary skill in the art to make and use embodiments of the invention. It is understood that the patentable scope of embodiments of the invention is defined by the claims, and can include additional components occurring to those skilled in the art. Such other examples are understood to be within the scope of the claims.

1-22. (canceled)

23. A combination oven assembly, comprising:
a housing defining an interior cavity;
a microwave cooking subassembly disposed and adjacent and through an opening in a top surface of said cavity and configured to direct microwave energy into said cavity;
a turntable disposed at the bottom of said cavity; and
a radiant heat cook subassembly disposed at the bottom and side exterior surfaces of said cavity and configured to heat the surfaces of the cavity from the exterior of said cavity, said subassembly having a radiating heating element and at least one heat distribution plate having a channel therein and being disposed adjacent said element, said plate forming at least a portion of an exterior surface of said interior cavity.

24 . An assembly according to claim 1 further comprising first and second heat distribution plates disposed adjacent said heating element, said plates forming at least a portion of a surface of the interior cavity.

25. An assembly according to claim 1 further comprising three heat distribution plates disposed adjacent said heating element, each of said plates forming at least a portion of a surface of the interior cavity.

26. An assembly according to claim 25 wherein said heating element is in contact with at least one of said plates.

27. An assembly according to claim 26 wherein said plates form at least a portion of a bottom surface of said cavity.

28. An assembly according to claim 28 wherein at least one of said plates comprises a channel, and said heating element is disposed within said channel.

29. An assembly according to claim 26 wherein each of said plates comprises a channel, and said heating element is disposed within said channels.

30. An assembly according to claim 1 wherein said plate comprises a channel, and said heating element is disposed within said channel.

31. An assembly according to claim 1 further comprising a rack removably disposed within said cavity, and wherein the turntable is disposed within a void of said rack.

32. An assembly according to claim 31 further comprising a heat distribution plate disposed adjacent said radiant heating element, said plate forming at least a portion of a surface of said cavity.

33. An assembly according to claim 31 further comprising three heat distribution plates disposed adjacent said heating element, said plates forming at least a portion of a surface of said cavity.

34. An assembly according to claim 33 wherein at least one of said plates comprises a channel, and said heating element is within said channel.

35. A method for operating a combination oven having an interior cavity, comprising:
selectively directing microwave energy into said cavity of said oven;
selectively directing energy into the interior cavity with a heating element disposed outside of the interior cavity; and
selectively operating a turntable disposed in the interior cavity.

36. A method according to claim 35 wherein selectively directing energy with the heating element comprises heating at least one surface of the interior cavity from the outside of the interior cavity.

37. A method according to claim 35 wherein selectively directing energy with the heating element comprises heating a plurality of surfaces of the interior cavity from the outside of the interior cavity.

38. A method according to claim 35 wherein selectively directing energy with the heating element comprises heating at least one heat distribution plate that forms a surface of the interior cavity.

37. A method according to claim 35 wherein selectively directing energy with the heating element comprises heating a plurality of heat distribution plates that form a surface of the interior cavity, with said heating element being in contact with at least one of the heat distribution plates.

38. A method in accordance with claim 37 wherein at least one of said plates comprises a channel, and wherein said the heating element is disposed and crimped within said channel.
